(19) United States
(12) Patent Application Publication
(10) Pub. No.: US 2005/0251305 A1
(43) Pub. Date: Nov. 10, 2005

(54) Electronic control apparatus

(76) Inventors: Junkei Sato, Sendai (JP); Akihiro Sasaki, Sendai (JP)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/517,123

(22) PCT Filed: May 28, 2003
(86) PCT No.: PCT/US03/16723

§ 371 Date: Dec. 1, 2004

(30) Foreign Application Priority Data
Jun. 3, 2002 (JP) 2002-160990

(51) Int. Cl. G06F 7/00; G06F 12/08

(52) U.S. Cl. 701/35; 711/165; 711/202

(57) ABSTRACT

The objective is to provide an electronic control apparatus capable of overwriting data in a nonvolatile memory, even during control operation. An ECU (10) includes a CPU (100), a flash EEPROM 101, and a calibration RAM (102). When calibration is performed, data in a calibration area of the flash EEPROM (101) is stored into the calibration RAM (102). A memory area of the calibration RAM (102) is overlapped over the calibration area to perform calibration. The data in the calibration area is written into the calibration RAM (102). When the calibration is completed, a super-user mode is entered in which the data stored in the calibration RAM (102) is written into the flash EEPROM (101) by use of a control register (113).

### BACKGROUND OF THE INVENTION

The present invention relates to electronic control apparatus for controlling a device, and more specifically to an electronic control apparatus capable of overwriting control data.

Control data, such as control programs and control parameters for controlling a device and so forth, is stored in a nonvolatile memory (ROM) so that it is not erased even when a battery is disconnected, and sometimes is supplied to the user. For example, an electronic control apparatus is used for control of engines, transmissions, and other automobile parts, and the resulting control data is stored in a ROM within the electronic control apparatus.

After the electronic control apparatus is installed in an automobile, an automobile manufacturer or dealer may desire to calibrate the control data in accordance with the characteristics of a device under control, such as the actual engine or transmission. Thus, the control data is often stored in a rewritable nonvolatile memory, such as an EEPROM (Electronically Erasable and Programmable ROM) or flash memory (flash EEPROM) such that the control data can be overwritten. A flash EEPROM is characterized by its relatively simple internal circuitry and low cost.

The storage area of the flash EEPROM is divided into a plurality of storage blocks, so that data is erased and/or written for each block during an overwrite. For example, with a 64 KB flash EEPROM having two storage blocks each with a storage capacity of 32 kilobytes (KB), a data overwrite process is performed every 32 kB. However, with the flash EEPROM, while a data overwrite process is performed, the data in that storage block cannot be read out.

Furthermore, with the flash EEPROM, the time required for a data overwrite process is very long, as compared to the time required for an overwrite in a RAM (Random Access Memory). Thus, if calibration is to be performed according to the characteristics of a device under control, such as an engine, data to be written into the flash EEPROM is typically stored temporarily in an external storage device, such as a debugger. Then, after the engine is stopped, the data stored in the external storage device is used to perform an overwrite process for the flash EEPROM. Thus, if multiple calibrations are to be performed for a single flash EEPROM, the above process needs to be repeated for each calibration, which is very time-consuming.

The present invention is designed in consideration of the above problem, and has as its objective to provide an electronic control apparatus capable of performing a data overwrite process for a nonvolatile memory, even during a control operation.

### SUMMARY OF THE INVENTION

To solve the aforedescribed problem, the invention according to claim 1 provides an electronic control apparatus having a nonvolatile memory and a volatile memory that store control data for controlling a device. The electronic control apparatus comprises a controller that uses data stored in the volatile memory to perform calibration of the control data, and execute a write of the data stored in the volatile memory into the nonvolatile memory when the calibration is completed.

The invention according to claim 2 provides an electronic control apparatus according to claim 1, wherein the controller stores the data in the nonvolatile memory to be calibrated into the volatile memory, when the calibration is started; and uses the data stored in the volatile memory to execute calibration of the control data.

The invention according to claim 3 provides an electronic control apparatus according to claim 1 or 2, wherein the controller further identifies an address of the nonvolatile memory to be calibrated, when the calibration is started, assigns the same address as that of the nonvolatile memory to the volatile memory, and preferentially executes data processing for the volatile memory during the calibration.

The invention according to claim 4 provides an electronic control apparatus according to any one of claims 1 through 3, further comprising a control register for controlling data in the nonvolatile memory, wherein the controller writes the address of the nonvolatile memory and calibrated control data into the control register when the calibration is completed and uses the address and calibrated control data written in the control register to execute a write into the nonvolatile memory.

The invention according to claim 5 provides an electronic control apparatus according to claim 4, further comprising an authority register for controlling the authority to permit use of the control register, wherein the control means sets the authority register when a write into the volatile memory is executed and clears the authority register after the write operation is completed.

The invention according to claim 6 provides an electronic control apparatus according to any one of claims 1 through 5, wherein the device has a plurality of units; the control data is stored in the nonvolatile memory corresponding to each of the units; the volatile memory has a storage capacity capable of storing control data corresponding to the unit to be calibrated.

The invention according to claim 7 provides an electronic control apparatus according to any one of claims 1 through 6, wherein the nonvolatile memory has at least two or more storage blocks; the write is executed for each storage block; when a write into the storage block is executed, another storage block is used to control the device.

According to the invention described in claim 1, data stored in the volatile memory is used to execute calibration of control data. When the calibration is completed, a write of the data stored in the volatile memory into the nonvolatile memory is executed. Thus, the volatile memory installed in the electronic control apparatus can be used to calibrate the nonvolatile memory that stores control data for controlling the device. In that case, calibration can be performed without the necessity of using an external storage device, such as a debugger. By performing such a write process, calibration can be achieved while the device under control is being operated.

According to the invention described in claim 2, when calibration is started, the data in the nonvolatile memory to be calibrated is stored into the volatile memory, and the data stored in the volatile memory is used to execute calibration of the control data. Thus, calibration can be achieved using pre-adjusted control data as a starting point. By storing standard control data in the nonvolatile memory, fine adjustment may only be performed depending on the characteristics of the device under control, so that efficient calibration can be accomplished.

According to the invention described in claim 3, when calibration is started, the address of the nonvolatile memory to be calibrated is identified. Then, the same address as that of the nonvolatile memory is assigned to the volatile memory, and data processing for the volatile memory is preferentially executed during calibration. That is, on the memory map, the memory area of the volatile memory is set as overlapped over the memory area to be calibrated. Thus, the electronic control apparatus can control the device by use of an address as usual, even during calibration.

According to the invention described in claim 4, when calibration is completed, the address of the volatile memory and calibrated control data are written into the control register. Then, the address and calibrated control data stored in the control register are used to execute a write into the nonvolatile memory. The data in the volatile memory can be reliably written into the nonvolatile memory via the control register.

According to the invention described in claim 5, the electronic control apparatus has an authority register for controlling the authority to permit use of the control register. When a write into the volatile memory is executed, the authority register is set; after the write is completed, the authority register is cleared. Thus, memory management for the control register may be performed only when a write is executed.

According to the invention described in claim 6, the volatile memory has a storage capacity capable of storing the control data corresponding to the unit to be calibrated. Thus, the storage capacity of the volatile memory can be restricted to that required for calibration, so that a reduction in size and cost of the electronic control apparatus can be achieved.

According to the invention described in claim 7, the nonvolatile memory comprises at least two or more storage blocks, and a write is executed for each storage block. When a write into the storage block is executed, another storage block is used to control the device. Thus, overwriting of control data in the nonvolatile memory can be achieved, while the device is being controlled. Accordingly, calibration can be achieved efficiently, without needing to reboot the device under control or the electronic control apparatus.

### BRIEF DESCRIPTION OF THE DRAWINGS

FIG. 1 is a schematic diagram depicting the overall configuration of an ECU (electronic control apparatus) according to an embodiment of the present invention.

FIG. 2 is a flow chart for explaining the overwrite process for a flash EEPROM.

FIG. 3 is another flow chart for explaining the overwrite process for a flash EEPROM.

FIG. 4 is an explanatory diagram for a memory map.

FIG. 5 is another explanatory diagram for a memory map.

FIG. 6 is a further explanatory diagram for a memory map.

FIG. 7 is yet another explanatory diagram for a memory map.

### DETAILED DESCRIPTION OF THE INVENTION

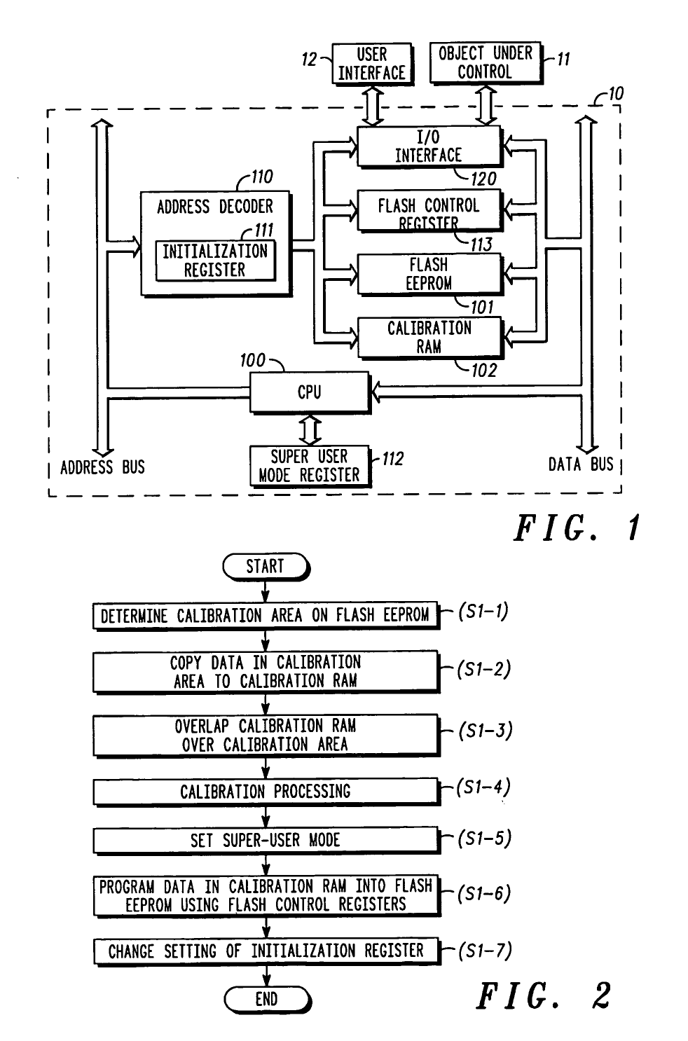

One embodiment of the present invention is described in detail below with reference to FIGS. 1 through 7. In the present embodiment, it is assumed, as shown in FIG. 1, that an object under control 11, such as an automobile engine, is controlled by use of an electronic control unit (ECU) 10. That is, after the ECU 10 is installed in the automobile, calibration of control parameters as control data is performed in order to control each of the units that comprise the automobile.

The ECU 10 includes a CPU 100, a flash EEPROM 101 as a nonvolatile memory, and a calibration RAM 102 as a volatile memory. The ECU 10 also includes a clock module, A/D converter, and so forth that are not shown. The CPU 10 is configured to execute various programs stored in the flash EEPROM 101, calibration RAM 102, and so forth.

The flash EEPROM 101 contains data regarding control commands and control parameters used by the ECU for control. The flash EEPROM 101 used in the present embodiment has a storage capacity of 64 kilobytes (KB), as a whole. The storage area is made up of 32 kB storage blocks (“block 0” and “block 1” on the memory map). For an overwrite, a data erasure and a write are performed on a block-by-block basis. The “block 0” contains data regarding control commands, while the “block 1” contains data regarding control parameters for each unit under control. In the present embodiment, it is assumed that a control command in the “block 0” causes an overwrite of the control parameter in the “block 1” during control of the object under control 11.

The calibration RAM 102 is a memory for temporarily storing predetermined data during calibration. For the calibration RAM 102, a memory having a storage capacity capable of storing control parameters corresponding to each unit under control should be used. The calibration RAM 102 in the present embodiment has a storage capacity of 2 kB.

The ECU 10 further includes an input/output interface section 120. Each portion of the ECU 10 is connected via the input/output interface section 120 to a user interface section 12 and an object under control 11. The user interface section 12 is used by the user to specify the object under control 11 and confirm the parameter.

The object under control 11 is a device, such as an engine, transmission, and other device to be controlled. The ECU 10 receives data from various sensors installed in the object under control 11, and outputs data to the actuator and so forth, via the input/output interface section 120.

The CPU 100 is connected to an address decoder 110 via an address bus. The address decoder 110 outputs, in accordance with an address signal from the CPU 100, a signal to its corresponding output terminal. In the present embodiment, the CPU 100 and address decoder 110 function as control means.

The address decoder 110 includes an initialization register 111. The initialization register 111 comprises an area for storing data regarding an address of an area where calibration is performed, and an area (activation bit) for storing data regarding the activation of the calibration RAM 102. In the present embodiment, when the calibration RAM 102 is activated, “1” is input to the activation bit.

Furthermore, the ECU 10 includes a super-user mode register 112 as an authority register, for controlling the mode (hereinafter referred to as “super-user mode) to grant authority regarding an overwrite for the flash EEPROM 101. When the super-user mode is set, “1” is input to the authority bit contained in the super-user mode register 112.

The ECU 10 further includes a flash control register 113 as a control register for controlling data in the nonvolatile memory. The flash control register 113 is used in the super-user mode. The flash control register 113 retains addresses to be written into the flash EEPROM 101, and calibrated control parameters.

Additionally, the CPU 100, calibration RAM 102, flash control register 113, and input/output interface section 120 are connected to the data bus, respectively, so that data is sent and received over the data bus.

Next, of the processes performed by the ECU 10, a process for rewriting data stored in the flash EEPROM 101 to data suitable for the object under control 11 is described with reference to FIGS. 2 through 7.

While the ECU 10 is controlling the object under control 11 in accordance with the data stored in the flash EEPROM 101, the user uses the user interface section 12 to issue an instruction for calibration regarding the object under control 11. This instruction is transferred to the CPU 100 via the input/output interface section 120 and data bus.

Then, the ECU 10 enters the calibration mode, where the process described in FIG. 2 is started. First, the CPU 100 determines a calibration area on the flash EEPROM 101 (S1-1). In that case, the CPU 100 inputs “1” to the activation bit of the initialization register 111 to activate the calibration RAM 102. Further, an address of an area where calibration is performed is stored in the initialization register 111.

Next, the data in the calibration area of the flash EEPROM is copied to the calibration RAM 102 (S1-2). This operation is described with reference to a memory map 500 shown in FIG. 4. In the memory map 500 are set a memory area 501 corresponding to the calibration RAM 102; a memory area 502 corresponding to the “block 0” of the flash EEPROM 101; and a memory area 503 corresponding to the “block 1” thereof. In the present embodiment, locations 6000 through 67FF in the memory area 503 are assumed to be a calibration area 504. Then, at step (S1-2), the data in the calibration area 504 is copied to the memory area 501 corresponding to the calibration RAM 102.

Next, the calibration RAM 102 is overlapped over the calibration area (S1-3). This operation is explained with reference to the memory map 510 shown in FIG. 5. Here, the memory area 501 of the calibration RAM 102 that is set on the memory map 510 is matched to the address that is set for the calibration area 504. That means the same address is assigned to the memory area 501 and calibration area 504.

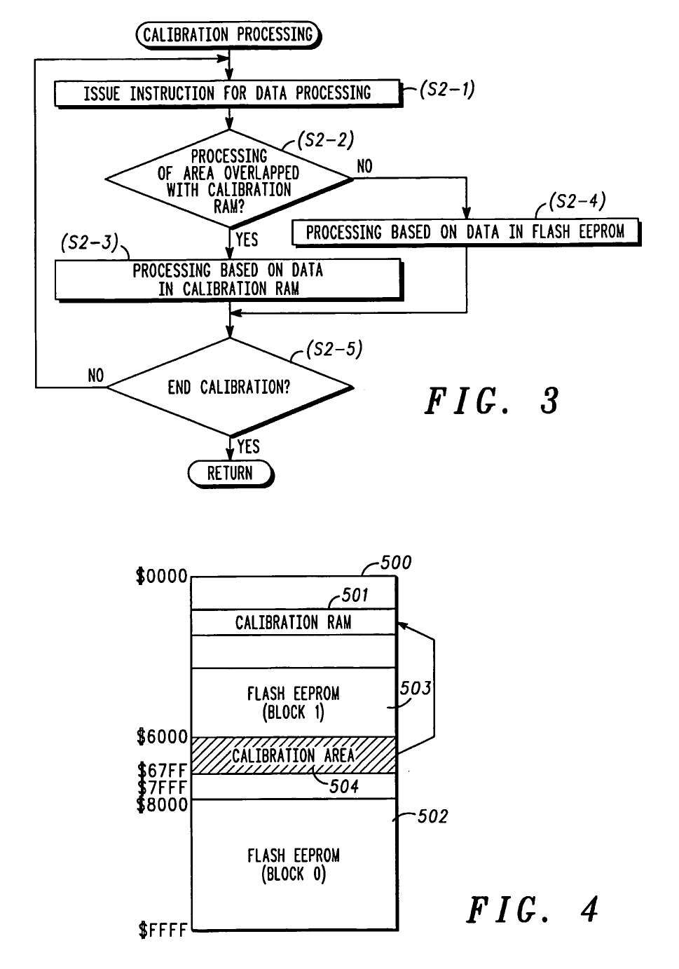

Next, calibration processing is executed according to the characteristics of the object under control 11 (S1-4). This process is explained with reference to the flow diagram shown in FIG. 3. The user uses the user interface section 12 to issue a modification instruction for parameter data and so forth that controls the object under control 11 (S2-1). In that case, the CPU 100 performs various processes, such as reading or overwriting of data on the memory map 510.

For processing of the memory area overlapped with the calibration RAM 102 (in case of “YES” to step (S2-2)), processing is performed in accordance with the data in the calibration RAM 102 (S2-3). That is, if “1” is set in the activation bit of the initialization register 111, each processing for the memory area where the same address (locations 6000 through 67FF in the present embodiment) is assigned to the flash EEPROM 101 and calibration RAM 102 is performed for the memory area 501 of the calibration RAM 102.

On the other hand, for processing of the area that is not overlapped with the calibration RAM 102 (in case of “NO”), processing is performed, as usual, on the data in the flash EEPROM 101 on the memory map 510 (S2-4).

Then if there is any new instruction for data processing (in case of “NO” to step (S2-5)), steps (S2-1) through (S2-4) are repeated to perform calibration. On the other hand, if a suitable parameter value is found for the object under control 11, the user uses the user interface section 12 to issue an instruction to end the calibration. If an instruction to end the calibration is issued (in case of “YES” to step (S2-5)), the routine returns to the flow shown in FIG. 2.

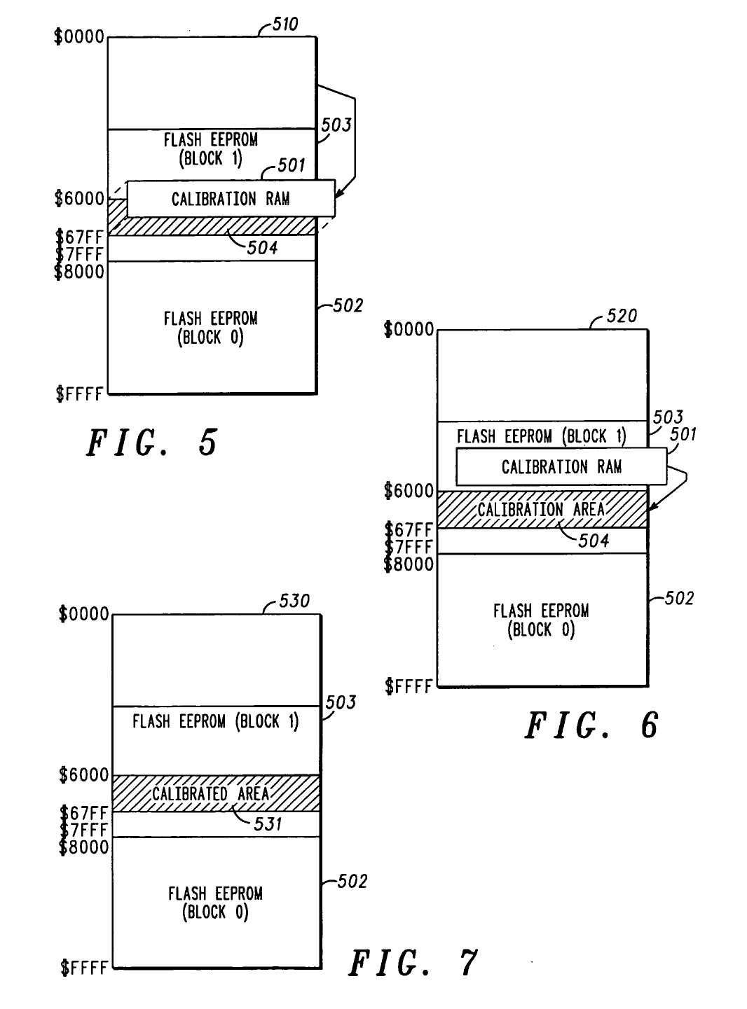

Next, the super-user mode is set (S1-5). Specifically, “1” is input to the authority bit of the super-user mode register 112. In that case, a write of the control parameter stored in the calibration RAM 102 into the flash EEPROM 101 is executed (S1-6). That is, as on the memory map 520 shown in FIG. 6, the data in the memory area 501 of the calibration RAM 102 that is set on the memory map 520 is written into the calibration area 504. Specifically, in the super-user mode, the flash control register 113 becomes accessible on the memory map. Then, the address and data stored in the calibration RAM 102 are written into the flash control register 113. Furthermore, in accordance with the address stored in the flash control register 113, the data stored in the flash control register 113 is written into the address on the flash EEPROM 101. Meanwhile, the ECU 10 continues to control the object under control 11 in accordance with the data stored in the memory area 502.

When the program is completed, the authority bit of the super-user mode register 112 is cleared, and the super-user mode is exited back to the normal mode. Furthermore, the setting of the initialization register 111 is changed (S1-7). Here, the activation bit of the initialization register 111 is cleared. This results in a memory map 530 shown in FIG. 7. That is, the memory area 501 of the calibration RAM 102 is removed, and the calibrated area 531 where the data of the calibration RAM 102 has been written is generated on the memory map 530. The ECU 10 then uses the overwritten data in the flash EEPROM 101 to control the object under control 11. Then, the overwrite of the flash EEPROM ends.

According to the aforedescribed embodiment, the following features can be attained. In the aforedescribed embodiment, the ECU 10 includes the flash control register 113, and enters the super-user mode when the calibration is completed. In this mode, the flash control register 113 becomes accessible on the memory map. Then, the data stored in the calibration RAM 102 is programmed into the flash EEPROM 101 by use of the flash control register 113. Thus, even when the ECU 10 is being operated, data in a certain area of the flash EEPROM 101 may be erased or overwritten. Conventionally, the object under control 11 must be stopped and control of the ECU 10 interrupted before overwriting the flash EEPROM 101. Thus, when another calibration is performed, it is necessary to reboot the ECU 10 and object under control 11. In that case, it would take time before the object under control 11 and so forth becomes stable after boot-up. By performing calibration while the object under control 11 is still operated as described in the present embodiment, the calibration task can be completed more quickly.

In the aforedescribed embodiment, the super-user mode can be used to perform calibration during operation of the ECU 10. Thus, calibration can be achieved efficiently, even when the calibration RAM 102 is relatively small, such as 2 kB. By using such a small-capacity calibration RAM 102, the ECU 10 can be reduced in size. Furthermore, because the RAM is rather expensive, use of a small calibration RAM 102 allows for a reduction in cost of the ECU 10.

In the aforedescribed embodiment, the calibration RAM 102 installed in the ECU 10 is used to overwrite data in the flash EEPROM 101. That is, the ECU 10 itself has a mechanism for overwriting data in the flash EEPROM 101. This eliminates the need for storing the calibrated data into an external storage device, such as a debugger. Thus, overwriting of data stored in the flash EEPROM 101 can be done efficiently.

In the aforedescribed embodiment, an address of the area where calibration is performed is stored in the initialization register 111, when the calibration is started. This address may be used to copy the data in the flash EEPROM 101 to the calibration RAM 102, and to set the memory area 501 of the calibration RAM 102 in the calibration area 504 of the flash EEPROM 101. That means the setting area for the calibration RAM 102 can be set according to the calibration area.

It should be appreciated that the aforedescribed embodiment may be modified as follows. In the aforedescribed embodiment, when the program is completed, the authority bit of the super-user mode register 112 is cleared, and the super-user mode is exited back to the normal mode. Meanwhile, the activation bit of the initialization register 111 is cleared. Instead, if calibration of another object under control 11 is performed continuously, an address of an area where a new calibration is performed may be set in the initialization register 111, while maintaining “1” for the activation bit of the initialization register 111. This enables calibrations to be performed continuously.

In the aforedescribed embodiment, a calibration RAM 102 having a storage capacity of 2 kB is used, although it is not limited thereto. It may have a capacity to cover a memory area required for a single calibration. Furthermore, a calibration RAM 102 having a larger storage capacity may be used to perform calibration for more objects under control 11 at a time.

In the aforedescribed embodiment, a control command for the “block 0” of the flash EEPROM 101 is used to overwrite the control parameter for the “block 1” during control operation of the object under control 11, although it is not limited thereto. It may be embodied in an electronic control apparatus that includes a flash EEPROM 101 that requires overwrites.

In the aforedescribed embodiment, the data in the calibration area of the flash EEPROM 101 is copied to the calibration RAM 102 at step (S1-2). Alternatively, this step may be skipped if there is no control data in the calibration area.

In the aforedescribed embodiment, the object under control 11, such as an automobile engine, is controlled by use of the electronic control apparatus (ECU 10), although it is not limited thereto. The point is, it may include a flash EEPROM 101 and may be embodied in an electronic control apparatus that implements overwrites of its data.

As described in detail above, according to the present invention, overwriting of data for the nonvolatile memory can be achieved even during control operation.

1. An electronic control apparatus having a nonvolatile memory and a volatile memory that store control data for controlling a device, the electronic control apparatus comprising:
a controller that uses data stored in the volatile memory to perform calibration of the control data and performs a write of the data stored in the volatile memory into the nonvolatile memory, when the calibration is completed.

2. The electronic control apparatus of claim 1, wherein the controller stores the data in the nonvolatile memory to be calibrated into the volatile memory, when the calibration is started and uses the data stored in the volatile memory to perform calibration of the control data.

3. The electronic control apparatus according to claim 1, wherein the controller further:
identifies an address of the nonvolatile memory to be calibrated when the calibration is started;
assigns the same address as that of the nonvolatile memory to the volatile memory; and
preferentially executes data processing for the volatile memory during the calibration.

4. The electronic control apparatus according to any one of claims 1 through 3, further comprising:
a control register for controlling data in the nonvolatile memory; and
wherein the controller writes the address of the nonvolatile memory and calibrated control data into the control register when said calibration is completed; and
uses the address and calibrated control data written in the control register to execute a write into the nonvolatile memory.

5. The electronic control apparatus according to claim 4, further comprising:
an authority register for controlling the authority to permit use of the control register; and
wherein the controller:
sets the authority register when a write into the volatile memory is executed; and
clears the authority register after the write is completed.

6. The electronic control apparatus according to any one of claims 1 through 5, wherein:
the device includes a plurality of units;
the control data is stored in the nonvolatile memory corresponding to each of the units; and
the volatile memory has a storage capacity capable of storing control data corresponding to the unit to be calibrated.

7. The electronic control apparatus according to any one of claims 1 through 6, wherein:
the nonvolatile memory includes at least two or more storage blocks;
the write is executed for each storage block; and
when a write into one of the storage blocks is executed, another storage block is used to control the device.
